(19) United States
(12) Patent Application Publication
(10) Pub. No.: US 2018/0196309 A1
(43) Pub. Date: Jul. 12, 2018

(54) COLOR TEMPERATURE ADJUSTMENT DEVICE AND METHOD OF LIQUID CRYSTAL PANEL AND LIQUID CRYSTAL PANEL

(71) Applicants: Shenzhen China Star Optoelectronics Technology Co. Ltd., Shenzhen, Guangdong (CN); Wuhan China Star Optoelectronics Technology Co. Ltd., Wuhan, Hubei (CN)

(72) Inventors: Jinjie ZHOU, Shenzhen (CN); Yujie BAI, Shenzhen (CN); Xingling GUO, Shenzhen (CN)

(73) Assignees: Shenzhen China Star Optoelectronics Technology Co. Ltd., Shenzhen, Guangdong (CN); WUHAN CHINA STAR OPTOELECTRONICS TECHNOLOGY CO. LTD, Wuhan, Hubei, (CN)

(21) Appl. No.: 15/310,680

(22) PCT Filed: Jul. 12, 2016
(86) PCT No.: PCT/CN2016/089744

§ 371 Date: Nov. 11, 2016

(30) Foreign Application Priority Data
May 4, 2016 (CN) 201610291088.6

(51) Int. Cl. G02F 1/1335; G09G 3/34; G02F 1/133

(52) U.S. Cl. CPC G02F 1/133602; G02F 1/13306; G09G 3/34

(57) ABSTRACT

The present disclosure provides a color temperature adjustment device and a method of a liquid crystal panel and a liquid crystal panel. Said color temperature adjustment device comprises: a sensor, sensing the color temperature of the liquid crystal panel; a controller, generating a control signal based on the sensed color temperature; a backlight integrated circuit, adjusting a driving current used to drive a backlight unit of the liquid crystal panel based on the control signal. The exemplary embodiments of the present disclosure can correct the drift of the color coordinate.

### BACKGROUND OF THE DISCLOSURE

### 1. Field of the Disclosure

The present disclosure relates to a liquid crystal display technical field, and in particular to a color temperature adjustment device and a method of a liquid crystal panel and a liquid crystal panel.

### 2. The Related Arts

The liquid crystal panel of the existing three-color liquid crystal display comprises a plurality of pixels, each pixels comprises three sub-pixels, which namely is red sub-pixels, green sub-pixels and blue sub-pixels. Alone with the development of the technology, four-color liquid crystal display is appeared, each pixel of the liquid crystal panel of the four-color liquid crystal display comprises four sub-pixels, except the three sub-pixels as described above, there is also a white sub-pixel. The screen of the liquid crystal display will be brighter after increasing the W sub-pixel, the color of the displayed image will be vivider. Before shipping the products, it is needed need to measure color gamut, color temperature and color coordinates and other parameters of the liquid crystal panel. The color coordinate (for example white color coordinate) of the manufactured liquid crystal panel may drift, but this drift can not be corrected, the color temperature and color coordinate are corresponded, therefore, to provide a color temperature adjustment device and method of the liquid crystal panel is required, in order to correct the drift of the color coordinate through adjusting the color temperature.

### SUMMARY OF THE DISCLOSURE

In order to overcome the deficiencies of the prior art, the exemplary embodiments of the present disclosure provide a method and a device which can adjust the color temperature of the liquid crystal panel.

Providing a color temperature adjustment device of a liquid crystal panel according to an aspect of the embodiments of the present disclosure, said color temperature adjustment device comprises: a sensor, sensing the color temperature of the liquid crystal panel; a controller, generating a control signal based on the sensed color temperature; a backlight integrated circuit, adjusting a driving current used to drive a backlight unit of the liquid crystal panel based on the control signal.

Optionally, the controller comprises: a compare module, comparing the difference value between the sensed color temperature and the predetermined color temperature with a threshold value; a signal generation module, generating a control signal when the difference value is larger than the threshold value.

Optionally, when the difference value is larger than the threshold value and is positive, the signal generation module generates a control signal which is used to reduce the driving current; when the difference value is larger than the threshold value and is negative, the signal generation module generates a control signal which is used to enhance the driving current.

Optionally, said color temperature adjustment device also comprises: a communication unit, which is communicated with external device.

Optionally, the backlight unit comprises at least one light emitting diode, each light emitting comprises a first light emitting diode, a second light emitting diode, a third light emitting diode and a fourth light emitting diode which are arranged in two column, the first light emitting diode and the second light emitting diode being sequentially arranged in the first column, the third light emitting diode and the fourth light emitting diode being sequentially arranged in the second column, the negative electrode of the fourth light emitting diode being connected with the positive electrode of the first light emitting diode, the negative electrode of the second light emitting diode being connected with the positive electrode of the third light emitting diode.

Providing a color temperature adjustment method of a liquid crystal panel according to another aspect of the embodiments of the present disclosure, said color temperature adjustment method comprises: (A) sensing the color temperature of the liquid crystal panel; (B) generating a control signal based on the sensed color temperature; (C) backlight integrated circuit, adjusting a driving current used to drive a backlight unit of the liquid crystal panel based on the control signal.

Optionally, the steps of generating a control signal based on the sensed color temperature comprise: comparing the difference value between the sensed color temperature and the predetermined color temperature with a threshold value; generating a control signal when the difference value is larger than the threshold value.

Optionally, when the difference value is larger than the threshold value and is positive, generating a control signal which is used to reduce the driving current; when the difference value is larger than the threshold value and is negative, generating a control signal which is used to enhance the driving current.

Optionally, the backlight unit comprises at least one light emitting diode, each light emitting comprises a first light emitting diode, a second light emitting diode, a third light emitting diode and a fourth light emitting diode which are arranged in two column, the first light emitting diode and the second light emitting diode being sequentially arranged in the first column, the third light emitting diode and the fourth light emitting diode being sequentially arranged in the second column, the negative electrode of the fourth light emitting diode being connected with the positive electrode of the first light emitting diode, the negative electrode of the second light emitting diode being connected with the positive electrode of the third light emitting diode.

According to the method and the device provided by the exemplary embodiments of the present disclosure, it is able to correct the drift of the color coordinate through adjusting the color temperature of the liquid crystal panel, enhancing the performance of the liquid crystal panel, optimizing the display effect of the liquid crystal panel.

The following description will partially elaborate the other aspects and/or advantages of the present disclosure, and a portion will be apparent through the description, or may be known through the embodiments of the present disclosure.

### BRIEF DESCRIPTION OF THE DRAWINGS

Describing the embodiments through combining the following drawings, the above description and/or the other purpose and the advantages of the present disclosure will be clearer, wherein:

FIG. 1 is a block diagram of a color temperature adjustment device of a liquid crystal panel of the embodiment of the present disclosure;

FIG. 2 is a schematic diagram of a backlight module of the embodiment of the present disclosure;

FIG. 3 is a schematic diagram of a backlight module of the other embodiment of the present disclosure;

FIG. 4 is a flow chart of a color temperature adjustment method of a liquid crystal panel of the embodiment of the present disclosure.

### DETAILED DESCRIPTION OF THE PREFERRED EMBODIMENTS

The exemplary embodiments of the present disclosure will now be described in detail, the examples of said embodiments are shown in the drawings, wherein the same reference numerals indicate the same portions. The followings will describe said embodiments through referring the drawings in order to explain the present disclosure.

To be noted that the described liquid crystal panel comprises a plurality of pixels, each pixel comprises a plurality of sub-pixels (for example three sub-pixels or four sub-pixels). Namely, the present disclosure can be applied to three colors liquid crystal display, four colors liquid crystal display or more colors liquid crystal display.

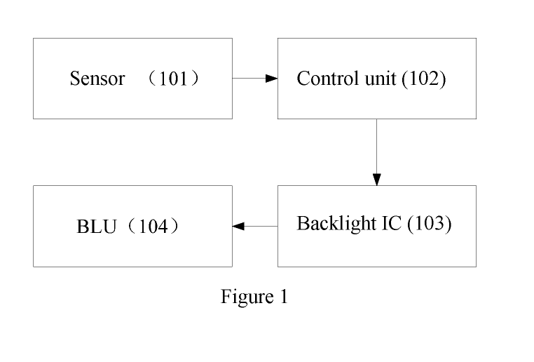

FIG. 1 is a block diagram of a color temperature adjustment device of a liquid crystal panel of the embodiment of the present disclosure. In the present embodiment, the liquid crystal panel comprises a substrate and a backlight unit, BLU. The backlight unit comprises a plurality of light emitting diode, LED, or organic light emitting diode, OLED, in order to irradiate light to the substrate, for liquid crystal panel displaying. The light emitting diode is described as an example here.

As shown in FIG. 1, the color temperature adjustment device according to the embodiment of the present disclosure comprises: a sensor 101, a controller 102 and a backlight integrated circuit, IC, 103.

The sensor 101 is used to sense the color temperature of the liquid crystal panel. The sensor 101 can be a color temperature meter or a chromathermograph, it can measure the emitted light of the liquid crystal panel during displaying.

The controller 102 is used to generate a control signal based on the sensed color temperature. The controller 102 can be single core, dual core or multi-core processor. The controller 102 comprises: a compare module, which is used to compare the difference value between the sensed color temperature and the predetermined color temperature with a threshold value; a signal generation module, which is used to generate a control signal when the difference value is larger than the threshold value.

As an example, when the difference value is larger than the threshold value and is positive, the signal generation module generates a control signal which is used to reduce the driving current; when the difference value is larger than the threshold value and is negative, the signal generation module generates a control signal which is used to enhance the driving current.

The backlight integrated circuit 103 is used to adjust a driving current used to drive a backlight unit 104 of the liquid crystal panel based on the control signal. The backlight integrated circuit 103 can be independent of the liquid crystal panel, may also be integrated into the backlight integrated circuit in the liquid crystal panel.

As an example, the backlight integrated circuit 103 adopts the backlight integrated circuit which is integrated in the liquid crystal panel. In this circumstance, the liquid crystal panel comprises a storage. The color temperature adjustment device of the embodiment of the present disclosure can be used to adjust the backlight unit of the liquid crystal panel. When the difference between the color temperature sensed by the sensor and the predetermined color temperature is larger than the threshold value, adjusting the driving current through the control signal, until the difference is less than or equal the threshold value. The storage of the liquid crystal panel can stores the driving current when the difference is less than or equal the threshold value. When the liquid crystal panel is operated (for example, starting the liquid crystal), using the driving current stored in the storage to drive the backlight unit of the liquid crystal panel.

As an example, the backlight integrated circuit 103 adopts the backlight integrated circuit which is independent to the liquid crystal panel. In this situation, the liquid crystal panel comprises a backlight integrated circuit thereof and a storage, the color temperature adjustment may comprise a communication unit. The color temperature adjustment device of the embodiment of the present disclosure can be used to adjust the backlight unit of the liquid crystal panel. When the difference between the color temperature sensed by the sensor and the predetermined color temperature is larger than the threshold value, adjusting the driving current through the control signal, until the difference is less than or equal the threshold value. When the difference is less than or equal the threshold value, sending the driving current to the liquid crystal panel through the communication unit, the storage of the liquid crystal panel stores the driving current. When the liquid crystal panel is operated (for example, starting the liquid crystal), the backlight integrated circuit of the liquid crystal panel uses the driving current stored in the storage to drive the backlight unit of the liquid crystal panel.

As an example, the communication unit of the color temperature adjustment device is also used to communicate with the external device (for example, personal computer, etc.).

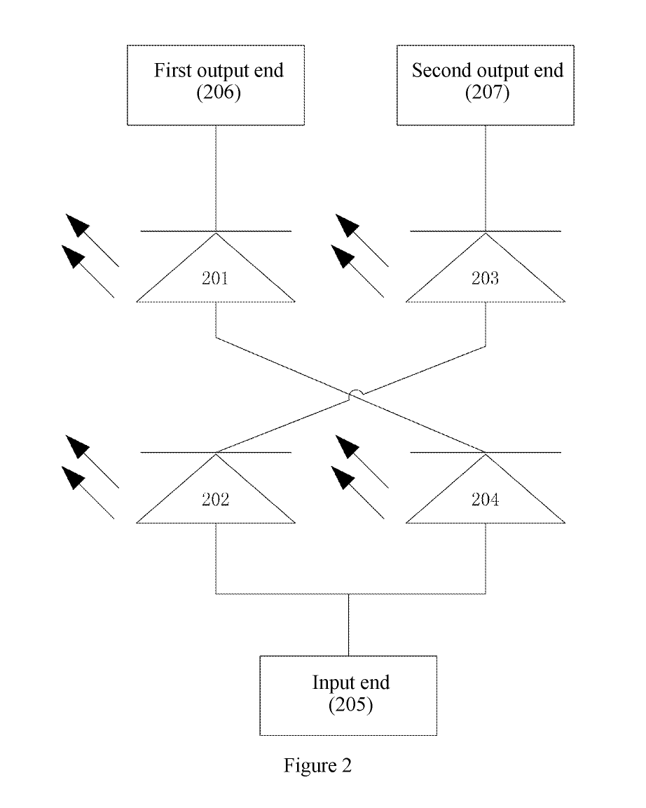

FIG. 2 is a schematic diagram of a backlight module of the embodiment of the present disclosure.

As shown in FIG. 2, the backlight unit of the exemplary embodiment comprises at least one input end 205 and at least two output ends 206 and 207, between the input end 205 and two output ends 206, 207 is at least provided a first light emitting diode 201, a second light emitting diode 202, a third light emitting diode 203 and a fourth light emitting diode 204 which are arranged in two column, the first light emitting diode 201 and the second light emitting diode 202 are sequentially arranged in the first column, the third light emitting diode 203 and the fourth light emitting diode 204 are sequentially arranged in the second column, the negative electrode of the fourth light emitting diode 204 is connected with the positive electrode of the first light emitting diode 201, the negative electrode of the second light emitting diode 202 is connected with the positive electrode of the third light emitting diode 203, the positive electrode of the second light emitting diode 202 and the positive electrode of the fourth light emitting diode 204 are connected with the input end 205, the negative electrode of the first light emitting diode 201 and the negative electrode of the third light emitting diode are respectively connected with the output end 206 and the output end 207.

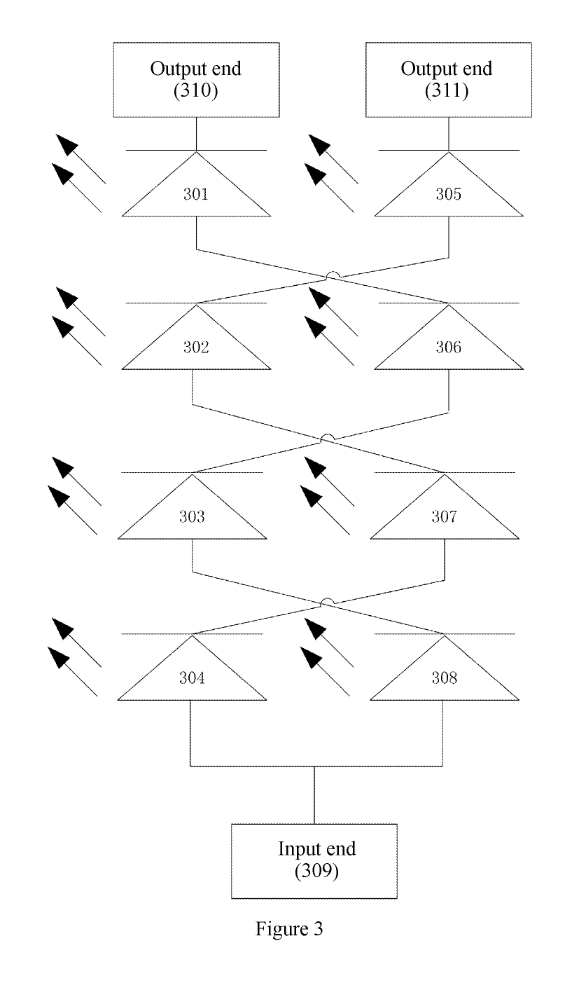

As an example, the four light emitting diode as above description form a light emitting diode, the backlight unit of the exemplary embodiment may comprise at least one (preferably is two or three) light emitting diode. The embodiment comprising such two backlight units of the light emitting diode is shown in FIG. 3.

As an example, the output end 206 and the output end 207 can be connected with the backlight integrated circuit 103 in FIG. 1. The light emitting diode of the backlight unit can be also arranged in three or more columns, each column corresponds to an output end. The backlight integrated circuit 103 controls the light emitting diode in series through the output end.

FIG. 3 is a schematic diagram of a backlight module of the other embodiment of the present disclosure.

As shown in FIG. 3, between the input end 309 and two output ends 310 and 311 is provided light emitting diode 301 to light emitting diode 308. The light emitting diode 304, the light emitting diode 307, the light emitting diode 302 and the light emitting diode 305 are sequentially in series. The light emitting diode 308, the light emitting diode 303, the light emitting diode 306 and the light emitting diode 301 are sequentially in series.

In the embodiments of the present disclosure, each light emitting diode of the backlight unit can be or not the light emitting diode with the same specification. The light emitting diode is provided into a crossed structure, comparing to the structure that the light emitting diodes in the same column are in series, the spacing between the adjacent light emitting diodes is larger. When adjusting the light emitting diodes which are in series, the affected region of the liquid crystal panel is larger, it is more beneficial to the adjustment of the color temperature of the liquid crystal panel.

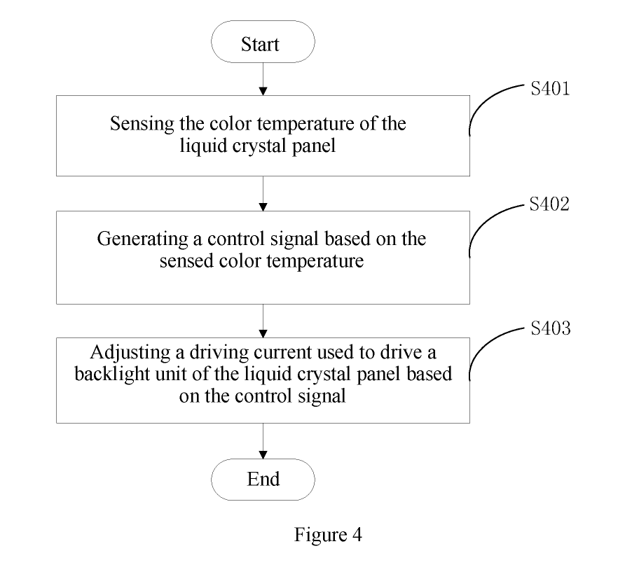

FIG. 4 is a flow chart of a color temperature adjustment method of a liquid crystal panel of the embodiment of the present disclosure.

As shown in FIG. 4, in step S401, sensing the color temperature of the liquid crystal panel. Measuring the emitting light of the liquid crystal panel through the color temperature meter or a chromathermograph.

In step S402, generating a control signal based on the sensed color temperature. As an example, the steps of generating a control signal based on the sensed color temperature comprise: comparing the difference value between the sensed color temperature and the predetermined color temperature with a threshold value; generating a control signal when the difference value is larger than the threshold value. The control signal can be pulse width modulated signal.

As an example, when the difference value is larger than the threshold value and is positive, generating a control signal which is used to reduce the driving current; when the difference value is larger than the threshold value and is negative, generating a control signal which is used to enhance the driving current.

In step S403, adjusting a driving current used to drive a backlight unit of the liquid crystal panel based on the control signal.

Moreover, the other embodiment of the present disclosure provides a liquid crystal panel which can comprise the backlight unit described in the above embodiments.

Furthermore, according to the above described method of the present disclosure can be implemented as a computer code in the computer readable recording medium. Skilled in the art can implement the computer code according to the above method. The above described method of the present disclosure will be implemented when the computer code is executed in the computer.

Moreover, each unit in the color temperature adjustment device of the liquid crystal panel according to the exemplary embodiments of the present disclosure can be implemented to hardware component. The processing performed by those skilled in the art according each limited unit can use FPGA or ASIC to achieve each unit.

The above description is only the specific embodiment in the present invention, be noted that, for those ordinary technical personnel in this art, it also can be improved and modified under the circumstance of without disobeying the present application principle, these improvements and modifications are also considered in the scope of the present application.

What is claimed is:

1. A color temperature adjustment device of a liquid crystal display panel, comprising:
a sensor, sensing the color temperature of the liquid crystal panel;
a controller, generating a control signal based on the sensed color temperature;
a backlight integrated circuit, adjusting a driving current used to drive a backlight unit of the liquid crystal panel based on the control signal.

2. The color temperature adjustment device as claimed in claim 1, wherein the controller comprises:
a compare module, comparing the difference value between the sensed color temperature and the predetermined color temperature with a threshold value;
a signal generation module, generating a control signal when the difference value is larger than the threshold value.

3. The color temperature adjustment device as claimed in claim 2, wherein when the difference value is larger than the threshold value and is positive, the signal generation module generates a control signal which is used to reduce the driving current; when the difference value is larger than the threshold value and is negative, the signal generation module generates a control signal which is used to enhance the driving current.

4. The color temperature adjustment device as claimed in claim 1, also comprising: a communication unit, which is communicated with external device.

5. The color temperature adjustment device as claimed in claim 1, wherein the backlight unit comprises at least one light emitting diode, each light emitting comprises a first light emitting diode, a second light emitting diode, a third light emitting diode and a fourth light emitting diode which are arranged in two column, the first light emitting diode and the second light emitting diode being sequentially arranged in the first column, the third light emitting diode and the fourth light emitting diode being sequentially arranged in the second column, the negative electrode of the fourth light emitting diode being connected with the positive electrode of the first light emitting diode, the negative electrode of the second light emitting diode being connected with the positive electrode of the third light emitting diode.

6. A color temperature adjustment method of a liquid crystal panel, comprising:
(A) sensing the color temperature of the liquid crystal panel;
(B) generating a control signal based on the sensed color temperature;
(C) backlight integrated circuit, adjusting a driving current used to drive a backlight unit of the liquid crystal panel based on the control signal.

7. The color temperature adjustment method as claimed in claim 6, wherein the steps of generating a control signal based on the sensed color temperature comprise: comparing the difference value between the sensed color temperature and the predetermined color temperature with a threshold value; generating a control signal when the difference value is larger than the threshold value.

8. The color temperature adjustment method as claimed in claim 6, wherein when the difference value is larger than the threshold value and is positive, generating a control signal which is used to reduce the driving current; when the difference value is larger than the threshold value and is negative, generating a control signal which is used to enhance the driving current.

9. The color temperature adjustment method as claimed in claim 6, wherein the backlight unit comprises at least one light emitting diode, each light emitting comprises a first light emitting diode, a second light emitting diode, a third light emitting diode and a fourth light emitting diode which are arranged in two column, the first light emitting diode and the second light emitting diode being sequentially arranged in the first column, the third light emitting diode and the fourth light emitting diode being sequentially arranged in the second column, the negative electrode of the fourth light emitting diode being connected with the positive electrode of the first light emitting diode, the negative electrode of the second light emitting diode being connected with the positive electrode of the third light emitting diode.

10. A liquid crystal panel, comprising: a backlight unit, wherein the backlight unit comprises at least one light emitting diode, each light emitting comprises a first light emitting diode, a second light emitting diode, a third light emitting diode and a fourth light emitting diode which are arranged in two column, the first light emitting diode and the second light emitting diode being sequentially arranged in the first column, the third light emitting diode and the fourth light emitting diode being sequentially arranged in the second column, the negative electrode of the fourth light emitting diode being connected with the positive electrode of the first light emitting diode, the negative electrode of the second light emitting diode being connected with the positive electrode of the third light emitting diode.
